(19) United States
(12) Patent Application Publication
(10) Pub. No.: US 2016/0054611 A1
(43) Pub. Date: Feb. 25, 2016

(54) DISPLAY SUBSTRATE, METHOD OF MANUFACTURING THE SAME, DISPLAY APPARATUS

(71) Applicant: BOE Technology Group Co., Ltd., Beijing (CN)

(72) Inventors: Chengtan Zhao, Beijing (CN); Jikai Yao, Beijing (CN); Guanbao Hui, Beijing (CN)

(21) Appl. No.: 14/573,523

(22) Filed: Dec. 17, 2014

(30) Foreign Application Priority Data
Aug. 22, 2014 (CN) 201410418860.7

(51) Int. Cl. G02F 1/1339; G02F 1/1368; G02F 1/1335

(52) U.S. Cl. CPC G02F 1/13394; G02F 1/133514; G02F 1/133512; G02F 1/133516; G02F 1/1368

(57) ABSTRACT

The present invention discloses a display substrate, a method of manufacturing the same, and a display apparatus. The display substrate comprises a substrate body and a support spacer provided on the substrate body. In the display substrate, a contact surface between the support spacer and the substrate body is configured to be a non-flat surface. On one hand, the non-flat contact surface has a larger contact area than a flat contact surface and increases an adhesion force between the support spacer and the substrate body. Thereby, it can prevent the support spacer from being separated from the substrate body. On the other hand, the non-flat contact surface can hinder the movement of the support spacer relative to the substrate body in some directions. Thereby, it also can prevent the support spacer from being separated from the substrate body.

### CROSS-REFERENCE TO RELATED APPLICATION

This application claims the benefit of Chinese Patent Application No. 201410418860.7 filed on Aug. 22, 2014 in the State Intellectual Property Office of China, the whole disclosure of which is incorporated herein by reference.

### BACKGROUND OF THE INVENTION

1. Field of the Invention

The embodiments of the present invention relates to a display technical field, more particularly, relates to a display substrate, a method of manufacturing the display substrate, and a display apparatus comprising the display substrate.

2. Description of the Related Art

With decrease of the cost and improvement of the manufacturing process of a thin film transistor liquid crystal display, the thin film transistor liquid crystal display has become the mainstream product in the field of flat panel display. The thin film transistor liquid crystal display generally comprises a color filter substrate, an array substrate and a liquid crystal material filled therebetween. FIG. 1 is an illustrative structure view of a color filter substrate in prior art. As shown in FIG. 1, the color filter substrate comprises a substrate 101, a color filter layer 102, a black matrix 103 formed in a gap of the color filter layer 102, and a support spacer 104 formed on the black matrix. The support spacer 104 is used to separate the array substrate from the color filter substrate by a distance, so as to ensure a normal liquid crystal display. In some similar displays, the support spacer may be made on the array substrate.

In a high resolution display products, since every element of the black matrix has a small size, the support spacer cannot be configured to have a large cross section. Also, in order to reduce a friction shadow in a friction orientation process, it also needs the support spacer to have a size as small as possible. As a result, a bottom area of the support spacer contacting the color filter substrate body or the array substrate body is decreased, and it causes a problem that the support spacer is easily fallen off the color filter substrate body or the array substrate body.

### SUMMARY OF THE INVENTION

The present invention has been made to overcome or alleviate at least one aspect of the above mentioned disadvantages.

According to an aspect of the present invention, there is provided a display substrate, comprising: a substrate body; and a support spacer provided on the substrate body, wherein a contact surface between the support spacer and the substrate body is configured to be a non-flat surface.

According to another aspect of the present invention, there is provided a method of manufacturing a display substrate comprising a substrate body and a support spacer, the method comprising steps of:

manufacturing the substrate body, wherein a region of the substrate body contacting the support spacer is configured to be a non-flat surface; and

forming the support spacer on the substrate body, wherein a surface of the support spacer contacting the substrate body is configured to be a non-flat surface,

wherein the non-flat surface of the substrate body mates with the non-flat surface of the support spacer, so that a non-flat contact surface is formed between the support spacer and the substrate body.

According to another aspect of the present invention, there is provided a display apparatus comprising the above display substrate.

### BRIEF DESCRIPTION OF THE DRAWINGS

The above and other features of the present invention will become more apparent by describing in detail exemplary embodiments thereof with reference to the accompanying drawings, in which:

FIG. 1 is an illustrative structure view of a color filter substrate in prior art;

FIG. 2 is an illustrative structure view of a color filter substrate according to an exemplary embodiment of the present invention;

FIG. 3 is an illustrative structure view of a color filter substrate according to an exemplary embodiment of the present invention;

FIG. 4 is an illustrative structure view of a color filter substrate according to an exemplary embodiment of the present invention;

FIG. 5 is an illustrative structure view of an array substrate according to an exemplary embodiment of the present invention;

FIG. 6 is an illustrative structure view of an array substrate according to an exemplary embodiment of the present invention;

FIG. 7 is an illustrative flow chart of manufacturing a color filter substrate according to an exemplary embodiment of the present invention;

FIG. 8 is an illustrative flow chart of manufacturing a color filter substrate according to an exemplary embodiment of the present invention;

FIG. 9 is an illustrative flow chart of manufacturing an array substrate according to an exemplary embodiment of the present invention; and

FIG. 10 is an illustrative flow chart of manufacturing an array substrate according to an exemplary embodiment of the present invention.

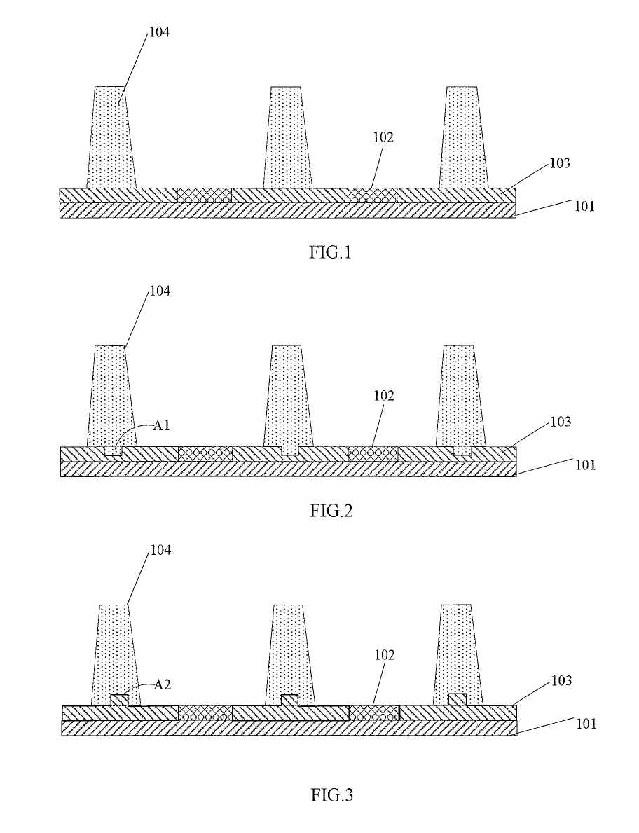

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The term “a display substrate” herein means a substrate formed with a support spacer on a body thereof. The substrate body may refer to the substrate self or other features formed on the substrate. In an exemplary embodiment, the display substrate may be a color filter substrate or an array substrate. In addition, the term “a contact surface between the support spacer and the substrate body is configured to be a non-flat surface” herein means that the contact surface between the support spacer and the substrate body comprise a non-flat feature.

Hereafter, it will describe an illustrative structure and a manufacturing method of a color filter substrate and an array substrate according to an exemplary embodiment with reference to drawings.

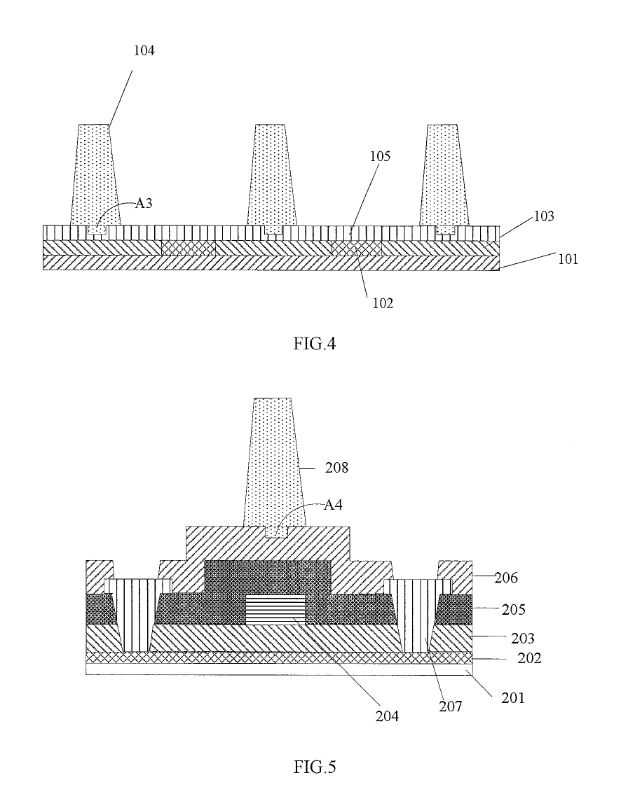

FIG. 2 and FIG. 3 show an illustrative structure view of a color filter substrate according to an exemplary embodiment. As shown in FIGS. 2-3, the color filter substrate comprises a substrate 101, a color filter layer 102, a black matrix 103 formed in a gap in the color filter layer 102, and a support spacer made on the black matrix 103. The substrate 101, the color filter layer 102 and the black matrix together constitutes a substrate body. A contact surface between the support spacer 104 and the black matrix 103 is configured to be a non-flat surface.

Herein, the substrate 101 may be made of, but not limited to, transparent glass, resin, etc. The black matrix 103 is mainly used to form a light-blocking region to block stray light, so as to prevent a light leakage between pixels corresponding to a transparent region. The color filter layer 102 comprises a R (red) filter, a G (green) filter and a B (blue) filter and is mainly used to produce three primary colors, Red, Green and Blue, by filtering, and mix the three primary colors with different strength ratio. In this way, it can show a variety of colors, so that a thin film transistor liquid crystal display can show full colors. Please be noted that the color filter layer is not limited to three primary colors RGB (Red Green Blue) in the field of the liquid crystal display. For example, the color filter layer may produce a variety of color combinations, such as, RGBW (Red Green Blue White), RGBY (Red Green Blue Yellow), CMYK (Cyan Magenta Yellow Black), etc. In an embodiment, the support spacer 104 may be a pillar-like support spacer. The support spacer 104 may be disposed on the black matrix and have any color.

In the color filter substrate according to an exemplary embodiment of the present invention, the contact surface between the support spacer and the black matrix is configured to be a non-flat surface. On one hand, the non-flat contact surface has a larger contact area than a flat contact surface and increases an adhesion force between the support spacer and the black matrix. Thereby, it can prevent the support spacer from being separated from the black matrix. On the other hand, the non-flat contact surface can hinder the movement of the support spacer relative to the black matrix in some directions. Thereby, it also can prevent the support spacer from being separated from the black matrix.

In an exemplary embodiment, as shown in FIG. 2, the black matrix 103 includes a recess A1 in the contact surface thereof. Meanwhile, the support spacer 104 includes a protrusion, corresponding to the recess A1, on the contact surface thereof. The protrusion on the support spacer 104 mates the recess A1 in the black matrix 103. In this way, the contact surface between the black matrix and the support spacer is configured to be the non-flat surface.

In an embodiment, the recess is totally located within the contact surface, and an opening area of the recess is less than an area of the contact surface. The recess may have any shape and may be located at any position in the contact surface.

In another exemplary embodiment, as shown in FIG. 3, the black matrix 103 includes a protrusion A2 on the contact surface thereof. Correspondingly, the support spacer 104 includes a recess, mating with the protrusion A2, in the contact surface thereof. Such embodiment is also included in the protect scope of the present invention.

Since the recess or the protrusion is formed in or on the contact surface of the black matrix, a shear stress is produced between the black matrix 103 and the support spacer 104 in various directions. Thereby, it can well prevent the support spacer from being separated from the black matrix. In practical application, the black matrix may include other shape feature (for example, a strip structure) on the contact surface, or the contact surface of the black matrix may be configured to be a single integral curved surface. In this way, it also can prevent the support spacer from being separated from the black matrix, and the scope of the present invention is not limited to these embodiments.

Please be noted that the contact surface between the support spacer and the substrate body may be a non-flat surface with a regular shape or an irregular shape. On one hand, the non-flat contact surface has a larger contact area than a flat contact surface and increases an adhesion force between the support spacer and the substrate body. Thereby, it can prevent the support spacer from being separated from the substrate body. On the other hand, the non-flat contact surface can hinder the movement of the support spacer relative to the substrate body in some directions. Thereby, it also can prevent the support spacer from being separated from the substrate body.

In an exemplary embodiment of the present invention, the bottom of the support spacer 104 contacting the black matrix has a diameter within a range of 7˜10 μm. Since the bottom diameter of the support spacer is very small, it can increase the opening rate. In addition, since the bottom surface of the support spacer contacting the black matrix is configured to be the non-flat surface, it can prevent the support spacer from being separated from the black matrix.

In an exemplary embodiment of the present invention, as shown in FIG. 2, the black matrix 103 includes only a single recess A1 in the contact surface corresponding to each support spacer, or as shown in FIG. 3, the black matrix 103 includes only a single protrusion A2 on the contact surface corresponding to each support spacer. In an example, the recess A1 or the protrusion A2 may have a diameter within a range of 3.5˜4.5 μm.

In practice application, according to actual requirements, the black matrix may include a plurality of recesses or protrusions in or on the contact surface corresponding to each support spacer.

FIG. 4 is an illustrative structure view of a color filter substrate according to an exemplary embodiment of the present invention.

The color filter substrate shown in FIG. 4 is different from the color filter substrate shown in FIGS. 2 and 3 in that: the color filter substrate shown in FIGS. 2 and 3 does not include a color filter protection layer, and the support spacer 104 is directly made on the black matrix 103; the color filter substrate shown in FIG. 4 includes a color filter protection layer 105, and the support spacer 104 is made on the color filter protection layer 105. In the color filter substrate shown in FIG. 4, the substrate 101, the color filter layer 102, the black matrix 103 and the color filter protection layer 105 together constitute a substrate body, and a contact surface between the support spacer 104 and the color filter protection layer 105 is configured to be a non-flat surface.

In an exemplary embodiment, as shown in FIG. 4, a recess A3 (or a protrusion, which is not shown) may be formed in the region of the color filter protection layer 105 corresponding to the support spacer 104.

In an exemplary embodiment, the color filter protection layer may be made of resin material.

FIG. 5 is an illustrative structure view of an array substrate according to an exemplary embodiment of the present invention.

As shown in FIG. 5, the array substrate comprises a substrate body. The substrate body comprises a substrate 201 as well as a TFT array and gate lines and data lines formed on the substrate 201. The TFT array comprises an active layer 202, a first insulation layer 203, a gate metal layer 204, a second insulation layer 205, a passivation layer 206, and a source drain metal layer 207. In addition, a support spacer 208 is formed on the passivation layer 206. A contact surface between the support spacer 208 and the passivation layer 206 is configured to be a non-flat surface. In an example, the support spacer 208 may be a pillar-like support spacer.

In an embodiment, the TFT array may have a structure same as a TFT array in prior art, and its description is omitted herein.

Also, it should be appreciated for those skilled in this art that the array substrate is not limited to a top gate type TFT array substrate shown in FIG. 5. In practice application, the array substrate may be a bottom gate type TFT array substrate. In the present invention, the TFT array may have any structure.

In an example, the TFT array may have a structure same as a TFT array in prior art, and its description is omitted herein.

Referring to FIGS. 2 and 3, in an exemplary embodiment, the passivation layer 206 may include a recess A4 in the contact surface corresponding to the support spacer 208, as shown in FIG. 5. In this case, the contact surface means a region of the passivation layer 206 on which the support spacer 208 is made. In an example, the contact surface may be located in a TFT zone, instead of a pixel zone. In practice application, the passivation layer 206 may include a protrusion in the contact surface corresponding to the support spacer 208, such embodiment is also included in the protect scope of the present invention.

In an exemplary embodiment, as shown in FIG. 5, the passivation layer 206 includes a single recess A4 in the contact surface corresponding to each support spacer 208, or a single protrusion on the contact surface corresponding to each support spacer 208.

In this case, the bottom of the support spacer contacting the passivation layer 206 may have a diameter within a range of 7˜10 μm, and the recess A4 (or the protrusion) may have a diameter within a range of 3.5˜4.5 μm.

In the array substrate according to the exemplary embodiment shown in FIG. 5, a contact surface between the support spacer and the passivation layer is configured to be a non-flat surface. On one hand, the non-flat contact surface has a larger contact area than a flat contact surface and increases an adhesion force between the support spacer and the passivation layer. Thereby, it can prevent the support spacer from being separated from the passivation layer. On the other hand, the non-flat contact surface can hinder the movement of the support spacer relative to the passivation layer in some directions. Thereby, it also can prevent the support spacer from being separated from the passivation layer.

FIG. 6 is an illustrative structure view of an array substrate according to an exemplary embodiment of the present invention.

The array substrate shown in FIG. 6 is different from the array substrate shown in FIG. 5 in that: the array substrate shown in FIG. 5 does not include a protection layer, and the support spacer 208 is directly made on the passivation layer 206; the array substrate shown in FIG. 6 includes a protection layer 209, and the support spacer 208 is made on the protection layer 209. In the array substrate shown in FIG. 6, the protection layer 209 is a portion of a substrate body, and the support spacer 208 is made on the protection layer 209. In this case, the contact surface between the support spacer 208 and the protection layer 209 is configured to be a non-flat surface.

In an exemplary embodiment, as shown in FIG. 6, the protection layer 209 includes a recess A5 (or a protrusion, which is not shown) in a region of the protection layer 209 corresponding to each support spacer 208. Except for these, the array substrate shown in FIG. 6 conforms to the array substrate shown in FIG. 5.

In an example, the protection layer 209 may be made of resin material.

In another exemplary embodiment of the present invention, there is also provided a method of manufacturing a display substrate. The method comprises steps of:

manufacturing a substrate body, wherein a region of the substrate body contacting a support spacer is configured to be a non-flat surface; and

forming the support spacer on the region of the substrate body, wherein a surface of the support spacer contacting the substrate body is configured to be a non-flat surface, wherein the non-flat surface of the substrate body mates with the non-flat surface of the support spacer, so that a non-flat contact surface is formed between the support spacer and the substrate body.

The display substrate is configured to be a substrate on which a support spacer is provided. For example, the display substrate may be a color filter substrate or an array substrate. Hereafter, it will describe in detail the method of manufacturing the display substrate, for example, the color filter substrate or the array substrate.

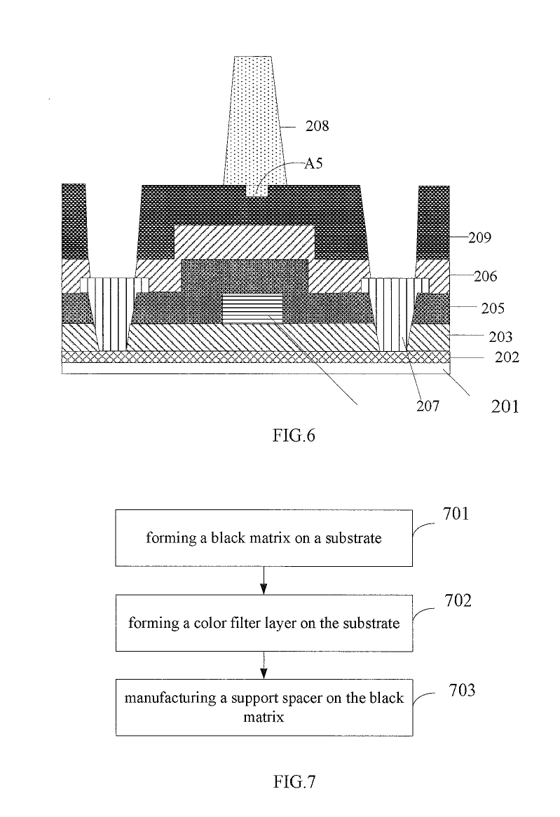

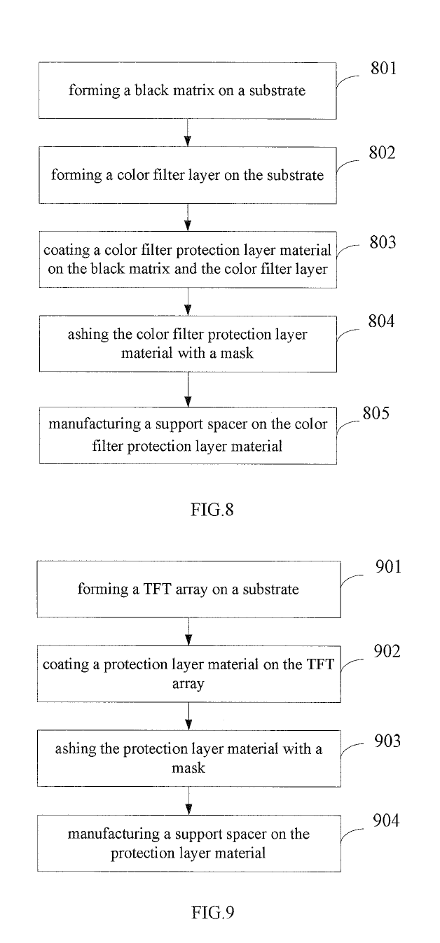

The above method may be adapted to manufacture the color filter substrate shown in FIGS. 2-3. In this case, as shown in FIG. 7, the method may comprise steps of:

Step 701: forming a black matrix on a substrate, wherein the black matrix is formed with a protrusion or a recess in a region of the black matrix contacting the support spacer.

In an example, the step 701 comprises steps of: depositing a black matrix material layer on the substrate; coating a photoresist on the black matrix material layer; exposing the coated photoresist with a double tone mask to form a complete-removing area, a half-removing area, and a fully-retention area; etching the black matrix material in the complete-removing area to remove the black matrix material corresponding to a transparent portion; ashing and removing the photoresist from the half-removing area; and incompletely etching the black matrix material in the half-removing area to form a protrusion or a recess. In this way, it can save at least one time of patterning process.

Step 702: forming a color filter layer on the substrate.

The substrate body of the color filter substrate is thus formed.

In an example, the step 702 comprises steps of: coating a red pixel resin layer with a thickness of about 2.5 μm on the color filter substrate by a dispersion coating process, wherein the red pixel resin layer is generally made of acrylic photosensitive resin or other carboxylic acid type pigment resin; forming a red pixel pattern on a certain region of a glass substrate by an exposure process and a chemical development process; and making a blue pixel pattern and a green pixel pattern (with a thickness of about 2.5 μm) on the color filter substrate by the same processes as the red pixel pattern. The red pixel pattern, the blue pixel pattern and the green pixel pattern are located in a gap in the black matrix and together constitute the color filter layer.

Step 703: manufacturing a support spacer on the black matrix, wherein the support spacer is formed with a recess or a protrusion, mating with the protrusion or the recess of the black matrix formed in step 701, in or on the contact surface of the support spacer.

In an example, the step 703 comprises steps of: coating a support spacer material on the color filter layer and the black matrix; and forming a pillar-like support spacer (PS) on the black matrix by an exposure process and a lithography process. The pillar-like support spacer may have eight-sided, quadrangular or circular cross section, a diameter of about 7˜10 μm, and a height of about 3.5 μm.

Since the black matrix includes the protrusion or the recess in the region for forming the support spacer, a recess or a protrusion, corresponding to the protrusion or the recess of the black matrix, is formed in or on the bottom of the support spacer on the region of the black matrix. As a result, a contact surface between the support spacer and the substrate body is configured to be a non-flat surface.

The method of the present invention also may be adapted to manufacture the color filter substrate shown in FIG. 4. In this case, as shown in FIG. 8, the method may comprise steps of:

Step 801: forming a black matrix on a substrate;

Step 802: forming a color filter layer on the substrate;

Step 803: coating a color filter protection layer material on the black matrix and the color filter layer; and

Step 804: ashing the color filter protection layer material with a mask, so that the color filter protection layer material is formed with a protrusion or a recess on or in a region of the color filter protection layer material contacting the support spacer.

The substrate body of the color filter substrate is thus formed.

Step 805: manufacturing a support spacer on the color filter protection layer material, wherein the support spacer is formed with a recess or a protrusion, mating with the protrusion or the recess of the color filter protection layer material formed in step 804, on or in the contact surface of the support spacer.

The method of manufacturing the display substrate of the present invention also may be adapted to manufacture the array substrate shown in FIG. 6. In this case, as shown in FIG. 9, the method may comprise steps of:

Step 901: forming a TFT array on a substrate;

Step 902: coating a protection layer material on the TFT array; and

Step 903: ashing the protection layer material with a mask, so that the protection layer material is formed with a protrusion or a recess in a region of the protection layer material contacting with the support spacer.

The substrate body of the array substrate is thus formed.

Step 904: manufacturing a support spacer on the protection layer material, wherein the support spacer is formed with a recess or a protrusion, mating with the protrusion or the recess of the protection layer material formed in step 903, in or on the contact surface of the support spacer.

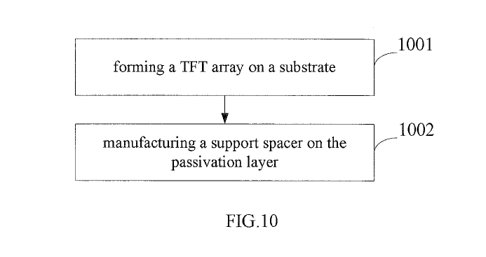

The method of manufacturing the display substrate of the present invention also may be adapted to manufacture the array substrate shown in FIG. 5. In this case, as shown in FIG. 10, the method may comprise steps of:

Step 1001: forming a TFT array on a substrate, wherein a passivation layer of the TFT array is formed with a protrusion or a recess in a region of the passivation layer contacting the support spacer.

The substrate body of the array substrate is thus formed.

Step 1002: manufacturing a support spacer on the passivation layer, wherein the support spacer is formed with a recess or a protrusion, mating with the protrusion or the recess of the passivation layer formed in step 1001, in or on the contact surface of the support spacer.

In another exemplary embodiment of the present invention, there is also provided a liquid crystal display apparatus comprising the display substrate according to any one of above embodiments.

In an example, the liquid crystal display apparatus may be any product or member with a display function, such as, an electronic paper, a mobile phone, a panel computer, a TV, a monitor, a notebook computer, a digital photo frame, a navigator, and so on.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A display substrate, comprising:
a substrate body; and
a support spacer provided on the substrate body,
wherein a contact surface between the support spacer and the substrate body is configured to be a non-flat surface.

2. The display substrate according to claim 1,
wherein the substrate body includes a protrusion or a recess on or in the contact surface thereof, and
wherein the support spacer includes a recess or a protrusion, mating with the protrusion or the recess of the substrate body, in or on the contact surface thereof.

3. The display substrate according to claim 2, wherein the recess is totally located within the contact surface.

4. The display substrate according to claim 2, wherein the support spacer has a bottom diameter within a range of 7˜10 μm.

5. The display substrate according to claim 2,
wherein the substrate body includes a single protrusion or a single recess, with a diameter within a range of 3.5˜4.5 μm, on or in the contact surface thereof.

6. The display substrate according to claim 2, wherein the display substrate is a color filter substrate.

7. The display substrate according to claim 6,
wherein the substrate body comprises a protection layer, and the protrusion or the recess of the substrate body is formed by the protection layer.

8. The display substrate according to claim 6,
wherein the protrusion or the recess of the substrate body is formed by a black matrix of the substrate body.

9. The display substrate according to claim 2, wherein the display substrate is an array substrate.

10. The display substrate according to claim 9,
wherein the substrate body comprises a protection layer, and the protrusion or the recess of the substrate body is formed by the protection layer.

11. The display substrate according to claim 9,
wherein the protrusion or the recess of the substrate body is formed by a passivation layer of the substrate body.

12. The display substrate according to claim 7, wherein the protection layer is a transparent resin layer.

13. The display substrate according to claim 10, wherein the protection layer is a transparent resin layer.

14. A method of manufacturing a display substrate comprising a substrate body and a support spacer, the method comprising steps of:
manufacturing the substrate body, wherein a region of the substrate body contacting the support spacer is configured to be a non-flat surface; and
forming the support spacer on the substrate body, wherein a surface of the support spacer contacting the substrate body is configured to be a non-flat surface,
wherein the non-flat surface of the substrate body mates with the non-flat surface of the support spacer, so that a non-flat contact surface is formed between the support spacer and the substrate body.

15. The method according to claim 14,
wherein said manufacturing the substrate body comprising steps of:
forming a black matrix on a substrate, wherein the black matrix is formed with a protrusion or a recess in a region of the black matrix contacting the support spacer; and
forming a color filter layer on the substrate,
wherein said forming the support spacer on the substrate body comprising steps of:
manufacturing the support spacer on the black matrix, wherein the support spacer is formed with a recess or a protrusion, mating with the protrusion or the recess of the black matrix, in or on the contact surface of the support spacer.

16. The method according to claim 15,
wherein said forming a black matrix on a substrate comprising steps of:
depositing a black matrix material layer on the substrate;
coating a photoresist on the black matrix material layer;
exposing the coated photoresist with a double tone mask to form a complete-removing area, a half-removing area, and a fully-retention area;
etching the black matrix material in the complete-removing area to remove the black matrix material corresponding to a transparent portion;
ashing and removing the photoresist from the half-removing area; and
incompletely etching the black matrix material in the half-removing area to form a protrusion or a recess.

17. The method according to claim 14,
wherein said manufacturing the substrate body comprising steps of:
forming a black matrix on a substrate;
forming a color filter layer on the substrate;
coating a color filter protection layer material on the black matrix and the color filter layer; and
ashing the color filter protection layer material with a mask, so that the color filter protection layer material is formed with a protrusion or a recess in a region of the color filter protection layer material contacting the support spacer,
wherein said forming the support spacer on the substrate body comprising step of:
manufacturing the support spacer on the color filter protection layer material, wherein the support spacer is formed with a recess or a protrusion, mating with the protrusion or the recess of the color filter protection layer material, at the contact surface of the support spacer.

18. The method according to claim 14,
wherein said manufacturing the substrate body comprising steps of:
forming a TFT array on a substrate;
coating a protection layer material on the TFT array; and
ashing the protection layer material with a mask, so that the protection layer material is formed with a protrusion or a recess in a region of the protection layer material contacting with the support spacer,
wherein said forming the support spacer on the substrate body comprising step of:
manufacturing the support spacer on the protection layer material, wherein the support spacer is formed with a recess or a protrusion, mating with the protrusion or the recess of the protection layer material, in or on the contact surface of the support spacer.

19. The method according to claim 14,
wherein said manufacturing the substrate body comprising step of:
forming a TFT array on a substrate, wherein a passivation layer of the TFT array is formed with a protrusion or a recess in a region of the passivation layer contacting the support spacer,
wherein said forming the support spacer on the substrate body comprising step of:
manufacturing the support spacer on the passivation layer, wherein the support spacer is formed with a recess or a protrusion, mating with the protrusion or the recess of the passivation layer, in or on the contact surface of the support spacer.

20. A display apparatus comprising the display substrate according to claim 1.
